(19) United States
(12) Patent Application Publication
(10) Pub. No.: US 2005/0249530 A1
(43) Pub. Date: Nov. 10, 2005

(54) Intermediate transfer blanket for use in electrophotographic printing

(76) Inventors: Michael E. McLean, Etowah, NC (US); Tony William Koons, Fletcher, NC (US)

Correspondence Address: DINSMORE & SHOHL LLP, One Dayton Centre, Suite 500, One South Main Street, Dayton, OH, 45402-2023, US

(21) Appl. No.: 11/124,430

(22) Filed: May 6, 2005

Related U.S. Application Data
(60) Provisional application No. 60/568,981, filed on May 7, 2004.

(51) Int. Cl. G03G 15/01

(52) U.S. Cl. 399/302; 399/297

(57) ABSTRACT

An intermediate transfer blanket for use in an electrophotographic imaging apparatus is provided which includes an inner body portion having at least one reinforcing layer, and an outer body portion having at least one reinforcing layer and an electrophotographic image transfer face, where the outer body portion is releasably securable to the inner body portion. The blanket construction allows the printing surface to be removed from the blanket and easily replaced in a cost effective manner.

### CROSS REFERENCE TO RELATED APPLICATIONS

This application claims the benefit of U.S. Provisional Application No. 60/568,981, entitled INTERMEDIATE TRANSFER BLANKET FOR USE IN ELECTROPHOTOGRAPHIC PRINTING, filed May 7, 2004. The entire contents of said application are hereby incorporated by reference.

### BACKGROUND OF THE INVENTION

The present invention relates to an intermediate transfer blanket construction, and more particularly, to an improved intermediate transfer blanket for use in electrophotographic printing applications.

In recent years, the use of on-demand digital printing machines utilizing electrophotographic systems has become widespread. In such a system, liquid or dry toner images are formed on a photosensitive drum and then electrically transferred onto an intermediate transfer blanket (in flat or cylindrical form) or belt for printing on a paper sheet or web. Intermediate transfer blankets are typically provided in the form of sheets that are wrapped around a drum or cylinder such that the opposite ends of the blanket are held in place by a variety of attachment methods employing either mechanical or adhesive clamping systems, or semi-permanent adhesive backings such as repositionable and/or pressure sensitive adhesives.

However, because electrophotography relies on nearly 100% transfer of the image, the top layer on such blankets is typically a release layer. For example, an intermediate transfer blanket is described in U.S. Pat. No. 6,551,716, the disclosure of which is incorporated herein by reference, which teaches a blanket body portion including an outer release coating. However, such release layers quickly deteriorate and do not have the ability to perform over an extended period of time due to their composition and thickness. The life of a release layer in an intermediate transfer blanket is typically less than one million impressions, resulting in the need to discard and/or replace the entire intermediate transfer blanket, which leads to considerable waste and cost.

Accordingly, there is still a need in the art for an improved intermediate transfer blanket for use in electrophotographic printing applications that provides improved print quality while being cost effective.

### SUMMARY OF THE INVENTION

Embodiments of the present invention meet that need by providing an intermediate transfer blanket for use in an electrophotographic imaging apparatus that is capable of being mounted onto a cylinder and in which the printing surface may be removed from the blanket and easily replaced in a cost effective manner.

According to one aspect of the invention, an intermediate transfer blanket for use in an electrophotographic imaging apparatus is provided comprising an inner body portion comprising at least one reinforcing layer, and an outer body portion comprising at least one reinforcing layer and a release layer having an electrophotographic image transfer face, where the outer body portion is releasably securable to the inner body portion.

The reinforcing layer comprising the inner and outer body portions is preferably selected from fabric, plastic film, metal, screening, and fiberglass. Preferably, the reinforcing layer comprises a woven fabric. The reinforcing layer preferably has a thickness of about 200 to 400 micrometers.

The outer body portion preferably further comprises a conductive layer over the reinforcing layer and a conforming layer over the conductive layer, with the release layer overlying the conforming layer. The conductive layer preferably comprises a polymeric material selected from acrylic elastomers, nitrile rubber, urethanes, vinyl, and silicone, and contains a conductive material therein. The conductive material preferably comprises carbon black. The conductive layer preferably has a resistance of less than about 1000 k ohms/square, and more preferably, between about 20 k ohms/square and 50 k ohms/square.

The conforming layer of the outer body portion preferably comprises a polymer having a Shore D hardness of less than about 70. Alternatively, the conforming layer may comprise a polymer layer having voids therein. The conforming layer may also contain a conductive material.

The release layer of the outer body portion preferably comprises a silicone-based material. The release layer may also contain a conductive material.

In one embodiment of the invention, the outer body portion may further include a barrier layer underlying the conductive layer. In this embodiment of the invention, the inner body portion preferably further includes a cushion layer overlying the reinforcing layer. The cushion layer preferably comprises nitrile rubber and is preferably adhered to the reinforcing layer. The cushion layer preferably has a Shore A hardness of between about 35 and 55. The cushion layer preferably has voids therein. The cushion layer may also include a conductive material therein.

In another embodiment of the invention, the inner body portion further comprises a cushion layer overlying the reinforcing layer, a conductive layer overlying the cushion layer, and a conforming layer overlying the conductive layer. In this embodiment, the outer body portion includes only the reinforcing layer and release layer.

In the above-described embodiments of the invention, the intermediate transfer blanket preferably includes first and second ends and is in the form of a flat blanket which is adapted to be wrapped around a blanket cylinder of an image transfer apparatus and secured in the non-print area of the cylinder.

In an alternative embodiment of the invention, the intermediate transfer blanket is gapless and in the form of a sleeve. In this embodiment, the blanket preferably includes a cushion layer which is permanently adhered to the inner body portion. The cushion layer preferably comprises a nitrile rubber and may include a conductive material therein. In this embodiment, the outer body portion of the blanket is in the form of a tube having an inner diameter, and is releasably securable to the inner body portion by expanding the inner diameter diametrically to fit over the inner body portion and allowing the inner diameter to contract so as to form an interference fit.

Also in this embodiment, the inner body portion is in the form of a tube having an inner diameter and is secured to a blanket cylinder by expanding the inner diameter of the inner body portion and allowing the inner diameter to contract so as to form an interference fit. The inner body portion preferably includes a plurality of apertures therein which allow air to pass through for use in expanding the outer body.

The intermediate transfer blanket of the present invention is constructed such that a user of an electrophotographic printing apparatus can easily replace the outer body portion, including the image transfer face, on-site, and more preferably, at or near the machinery. Thus, there is no longer a need to discard the entire transfer blanket when the release layer has reached the end of its useful life.

Accordingly, it is a feature of embodiments of the present invention to provide an intermediate transfer blanket for use in electrophotographic printing that may be readily mounted onto a cylinder and in which the printing surface may be removed from the blanket and replaced in a cost-effective manner. Other features and advantages of the invention will be apparent from the following description, the accompanying drawings, and the appended claims.

### BRIEF DESCRIPTION OF THE DRAWINGS

FIG. 1 is a schematic illustration of an electrophotographic imaging apparatus including an intermediate transfer blanket mounted on a blanket cylinder in accordance with an embodiment of the present invention;

FIG. 2 is an enlarged view of a flat intermediate transfer blanket wrapped around a cylinder and secured by a securing mechanism;

FIG. 3 is an enlarged and simplified sectional view of a gapless intermediate transfer blanket mounted on a blanket cylinder;

FIGS. 4A-4C illustrate fragmentary cross-sectional views of different embodiments of the intermediate transfer blanket of the invention taken along line 3—3 in FIG. 2;

FIG. 5 is fragmentary cross-sectional view of another embodiment of the image transfer blanket of the invention taken along line 4—4 in FIG. 3; and

FIG. 6 is a diagrammatic view of a gapless intermediate transfer blanket mounted on a cylinder, where the cylinder assembly and blanket are shown with layers that are cut away for illustrative purposes.

### DETAILED DESCRIPTION OF THE PREFERRED EMBODIMENTS

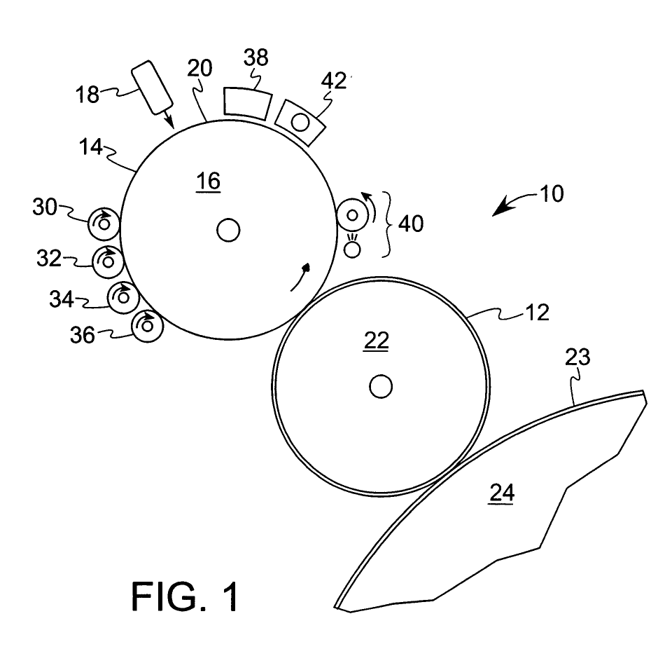

Reference is now made to FIG. 1, which schematically illustrates an electrophotographic imaging system 10 utilizing one embodiment of the intermediate transfer blanket 12 of the present invention. As is conventional in the art, the system 10 includes a photoconductor layer 14 typically mounted on a rotating drum 16. An electrical charge is imparted to the photoconductor layer 14 by charging apparatus 38. Drum 16 is caused to rotate about its axis by an electric motor or the like (not shown). Toner or ink is applied to photoconductor layer 14 on drum 16 by suitable means conventional in the art. For example, where colored toner or ink is used, individual colors (such as, for example, cyan, yellow, magenta, and black) may be applied to the drum by applicators 30, 32, 34, and 36, respectively.

An image to be reproduced is created by an imaging apparatus 18 such as a modulated laser beam scanning apparatus, an optical focusing device for imaging a copy on a drum, or other imaging apparatus as is known in the art. The image to be reproduced is focused by the imaging apparatus 18 upon the charged surface 20 of the photoconductor 14, at least partially discharging the photoconductor in the areas struck by light, thereby forming an electrostatic latent image.

The intermediate transfer blanket 12 is mounted on a blanket cylinder 22. As is known in the art, cylinder 22 is maintained at a suitable voltage and temperature for electrostatic transfer of a toner or ink image thereto from an image-bearing surface, such as the surface 20 of photoconductor layer 14. The formed image is then preferably transferred from the intermediate transfer blanket 12 onto a final substrate such as a paper web or sheet 23 using an impression cylinder 24 along with the application of heat and pressure. The toner may be in liquid or dry form. After transfer of the image, residual ink or toner is removed from the photoconductor surface 14 at cleaning station 40, and residual electrical charge may be dissipated from the photoconductor by an optional neutralizing lamp 42.

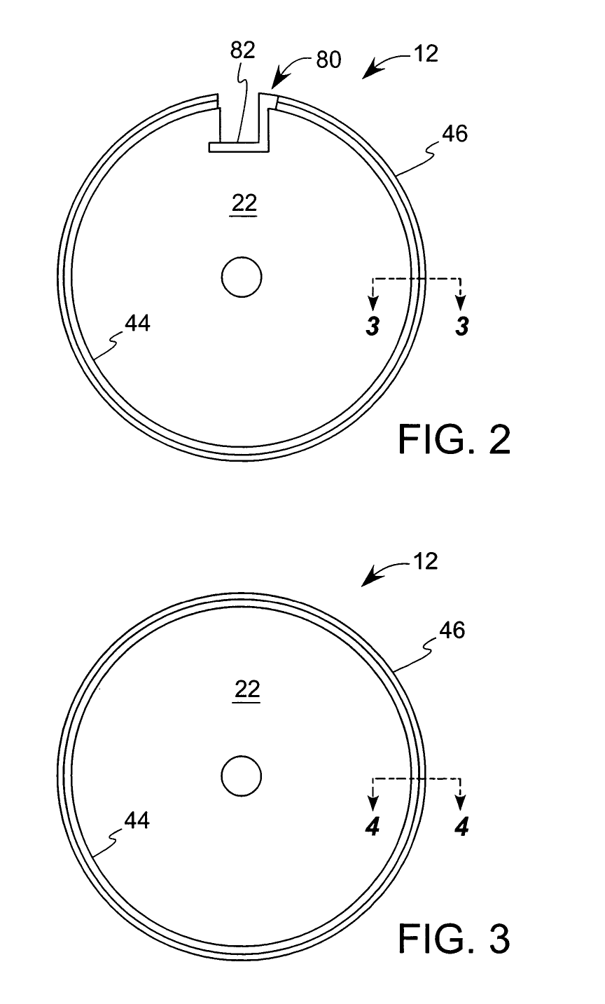

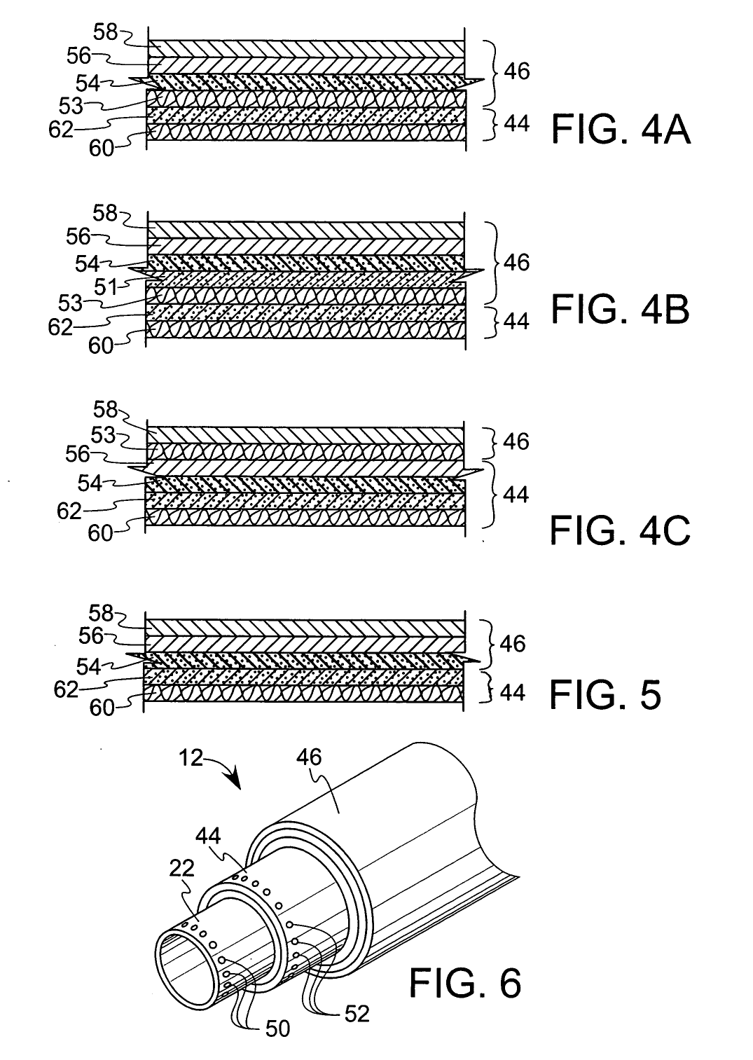

FIG. 2 illustrates an embodiment of the invention in which the intermediate transfer blanket is in the form of a flat, generally rectangular-shaped blanket 12 comprising inner and outer body portions 44 and 46. The details of the construction of embodiments of the inner and outer body portions of the flat blanket 12 are shown in FIGS. 4A-4C as described below. As shown in FIG. 2, the blanket is wrapped around the blanket cylinder 22 and the ends of the blanket are secured using a mechanism on one end which includes a mounting fitting 80 including mounting legs 82 as described in U.S. Pat. No. 5,745,829, incorporated herein by reference. Alternatively, the back of the inner body and the ends of the blanket may be secured using a conventional semi-permanent adhesive or by using a mounting fitting on both ends. When it is desirable to remove the outer body portion, the securing mechanism may be unlocked and the outer body is peeled from the inner body and replaced with a new outer body.

FIG. 4A illustrates a cross-sectional view of one embodiment of the flat intermediate transfer blanket 12 taken along lines 3—3 in FIG. 2. As shown, the blanket includes an outer body portion 46 and an inner body portion 44. The outer body portion 46 preferably includes a reinforcing layer 53, a conductive layer 54, a conforming layer 56 overlying the conductive layer, and a release layer 58. The layers may be adhered together using conventional blanket adhesives as is known in the art.

The release layer 58, which is the outermost layer when the blanket is mounted on a blanket cylinder, is preferably formed from a silicone-based material, and more preferably, from a condensation type silicone material. Alternative polymeric materials may be used as long as they have the required release properties for the selected toner or ink. Suitable polymeric materials include compounded nitrile rubber, urethanes, vinyls, polyethylene, polyvinylidene fluoride, and other fluoropolymers.

The conforming layer 56 is preferably a relatively soft elastomer, such as compounded nitrile rubber, polyurethane, fluoropolymers, or an acrylic-based elastomer, and preferably has a Shore D hardness of less than about 70. However, it should be appreciated that the hardness may be as low as 30 Shore A. The nominal Shore value may vary based on the specific printing application. Alternatively, the conforming layer may be comprised of sub-layers of varying hardness, or it may comprise a polymer layer having voids therein. The conforming layer functions to provide good conformation of the blanket to the image forming surface (and the image on the image forming surface) at the pressures used in transfer of the image from the image forming surface to the blanket. Optionally, the conforming layer and/or the release layer may be made conductive by the addition of anti-static materials such as carbon black, metal fibers, and epichlorohydrin.

Conductive layer 54 is preferably formed from acrylic rubber loaded with conductive carbon black. The resistance of the conductive layer should preferably be less than 1000 k ohms/square and preferably between about 20 k ohms/square and about 50 k ohms/square. This value will depend on the resistivity of the layers above the conductive layer as well as on the aspect ratio of the blanket. In general, the resistance should be low enough so that the current flowing on the conducting layer does not cause a substantial variation of voltage along the surface of the blanket.

As shown in FIG. 4A, the inner body portion 44 comprises a reinforcing layer 60 and a cushion layer 62. The reinforcing layer 60 is preferably formed of a woven fabric such as cotton or NOMEX® and preferably has a thickness between about 200 and about 400 micrometers.

Cushion layer 62 preferably comprises nitrile rubber. The cushion layer preferably has a Shore A hardness of less than about 85 and more preferably, between about 35 and 55. The cushion layer preferably has a thickness of about 400 and about 1,500 micrometers. The cushion layer is preferably loaded with carbon black to increase its electrical conductivity. Cushion layer 62 preferably contains voids (about 30-70% by volume). The cushion layer functions to absorb deflections of the outer body portion during printing operations. The cushion layer preferably has a compressibility range of no more than about 20 percent (based on ISO Standard method 12636 sections 4.4/4.5) but it should be appreciated that the nominal compressibility value will change based on the specific printing application. The cushion layer and reinforcing layer may be adhered together using a conventional adhesive.

The reinforcing layer 60 of the inner body portion may further include a semi-permanent adhesive (not shown) which provides enough adhesive strength for the inner body portion to be releasably secured to the cylinder.

FIG. 4B illustrates an alternative embodiment of the invention where the outer body portion includes a barrier layer 51 between the reinforcing layer 53 and the conductive layer 54. The barrier layer is preferably comprised of a material which prevents penetration of solvents and press chemicals into the inner body portion. The barrier layer is preferably resistant to Isopar™ and toner. Alternatively, the reinforcing layer 53 may be comprised of a material which functions as a barrier layer. The bottom layer of the outer body portion may further include a semi-permanent adhesive (not shown) to enable the outer body to be releaseably secured to the inner body.

FIG. 4C illustrates yet another alternative embodiment of the invention where the outer body portion 46 comprises reinforcing layer 53 and release layer 58, and inner body portion includes reinforcing layer 60, cushion layer 62, a conductive layer 54, and a conforming layer 56.

FIG. 3 illustrates an alternative embodiment of the invention in which the intermediate transfer blanket is in the form of a gapless (seamless) blanket sleeve mounted on a blanket cylinder 22. As shown, gapless transfer blanket sleeve 12 includes a base (inner body) portion 44 and an image transfer (outer body) portion 46. The details of the construction of preferred embodiments of transfer blanket 12 are shown in FIG. 5. The gapless blanket includes an inner body portion 44 and outer body portion 46 as described above, where the outer body portion includes a reinforcing layer 53, a conductive layer 54, a conforming layer 56 overlying the conductive layer, and a release layer 58. The inner body portion includes a reinforcing layer 60 as described above. In this embodiment of the invention, the blanket includes a cushion layer 62 which is permanently adhered to the inner body portion 44.

FIG. 6 illustrate the gapless intermediate transfer blanket sleeve 12 mounted on a blanket cylinder 22. The layers of the blanket are illustrated in cut out fashion progressively cut away from the left hand side of the figure so that each body portion may be identified and discussed. The apertures 52 are shown for illustrative purposes only and would actually be located in-line with apertures 50. As shown in FIG. 6, the inner body portion 44 is in the form of a hollow tube. The inner body portion may take on any number of diameters, lengths and thicknesses, depending on the overall diameter of the blanket cylinder assembly.

In this embodiment, the inner body portion 44 is preferably secured to the blanket cylinder 22 by expanding the body radially outward using a pressurized source, such as compressed air, against the inner diameter of the inner body portion. For this purpose, a plurality of apertures 50 may be provided on the end of and extending through to the periphery of blanket cylinder 22 which receive a source of pressurized gas. Pressure is selectively applied from a source coupled to the blanket cylinder as is known in the art. This method of mounting is described in commonly-assigned U.S. Pat. No. 6,799,511, which is incorporated herein by reference.

The outer body portion 46 is removably attachable to the surface of the inner body portion 44. The inner body portion may also be provided with apertures 52 aligned with apertures 50 in blanket cylinder 22. Outer body portion 46 is expandable radially outward by applying a sufficient amount of gas pressure to allow the outer body portion to temporarily expand and slip over inner body portion 44 on the cylinder 22. When the pressure is relieved, the outer body portion contracts around the inner body portion 44 and is frictionally secured thereto.

When the imaging surface of the gapless intermediate transfer blanket needs to be replaced, the inner body portion 44 may remain on the blanket cylinder 22 and the entire outer body portion 46 may be removed by the application of gas pressure to temporarily expand it and permit it to be replaced on-site by an end user.

Having described the invention in detail and by reference to preferred embodiments thereof, it will be apparent that modifications and variations are possible without departing from the scope of the invention.

1. An intermediate transfer blanket for use in an electrophotographic imaging apparatus comprising:
an inner body portion comprising at least one reinforcing layer;
an outer body portion comprising at least one reinforcing layer and a release layer having an electrophotographic image transfer face, said outer body portion being releasably securable to said inner body portion.

2. The intermediate transfer blanket of claim 1 wherein said reinforcing layer is selected from the group consisting of fabric, plastic film, metal, screening, and fiberglass.

3. The intermediate transfer blanket of claim 2 wherein said reinforcing layer comprises a woven fabric.

4. The intermediate transfer blanket of claim 1 wherein said reinforcing layer has a thickness of between about 200 to about 400 micrometers.

5. The intermediate transfer blanket of claim 1 wherein said outer body portion further comprises a conductive layer overlying said reinforcing layer, a conforming layer overlying said conductive layer, and a release layer overlying said conforming layer.

6. The intermediate transfer blanket of claim 5 wherein said conductive layer comprises a polymeric material selected from acrylic elastomers, nitrile rubber, urethanes, vinyl, and silicone, said layer containing a conductive material therein.

7. The intermediate transfer blanket of claim 5 wherein said conductive material comprises carbon black.

8. The intermediate transfer blanket of claim 5 wherein said conductive layer has a resistance of less than about 1000 k ohms/square.

9. The intermediate transfer blanket of claim 5 wherein said conductive layer has a resistance of between about 20 k ohms/square and about 50 k ohms/square.

10. The intermediate transfer blanket of claim 5 wherein said conforming layer comprises an elastomer having a Shore D hardness of less than about 70.

11. The intermediate transfer blanket of claim 5 wherein said conforming layer has a minimum Shore A hardness of 30.

12. The intermediate transfer blanket of claim 5 wherein said conforming layer includes a conductive material therein.

13. The intermediate transfer blanket of claim 5 wherein said release layer comprises a silicone-based material.

14. The intermediate transfer blanket of claim 5 wherein said release layer comprises a fluoropolymer.

15. The intermediate transfer blanket of claim 5 wherein said release layer includes a conductive material therein.

16. The intermediate transfer blanket of claim 1 wherein said outer body portion further comprises a barrier layer.

17. The intermediate transfer blanket of claim 1 wherein said inner body portion further includes a cushion layer overlying said reinforcing layer.

18. The intermediate transfer blanket of claim 17 wherein said cushion layer comprises nitrile rubber.

19. The intermediate transfer blanket of claim 17 wherein said cushion layer is adhered to said reinforcing layer.

20. The intermediate transfer blanket of claim 17 wherein said cushion layer has a Shore A hardness of between about 35 and 55.

21. The intermediate transfer blanket of claim 17 wherein said cushion layer has a conductive material therein.

22. The intermediate transfer blanket of claim 17 wherein said cushion layer has voids therein.

23. The intermediate transfer blanket of claim 1 wherein said blanket includes first and second ends, and said blanket is adapted to be secured in the non-print area of a blanket cylinder.

24. The intermediate transfer blanket of claim 1 wherein said inner body portion further includes a cushion layer overlying said reinforcing layer, a conductive layer overlying said cushion layer, and a conforming layer overlying said conductive layer.

25. The intermediate transfer blanket of claim 1 wherein said blanket is gapless.

26. The intermediate transfer blanket of claim 25 including a cushion layer adhered to said inner body portion.

27. The intermediate transfer blanket of claim 26 wherein said cushion layer comprises a nitrile rubber.

28. The intermediate transfer blanket of claim 26 wherein said cushion layer includes a conductive material therein.

29. The intermediate transfer blanket of claim 25 wherein said outer body portion has an inner diameter and is releasably securable to said inner body portion by expanding said inner diameter to fit over said inner body portion.

30. The intermediate transfer blanket of claim 25 wherein said inner body portion has an inner diameter and is secured to a blanket cylinder by expanding said inner diameter of said inner body portion.

31. The intermediate transfer blanket of claim 25 wherein said inner body portion includes a plurality of apertures therein.
